(19) United States
(12) Patent Application Publication
(10) Pub. No.: US 2011/0140463 A1
(43) Pub. Date: Jun. 16, 2011

(54) FRICTIONAL AND GRAVITATIONAL DOOR SECURITY DEVICE

(76) Inventor: Sean Michael Nalepka, Howell, MI (US)

(21) Appl. No.: 12/635,735

(22) Filed: Dec. 11, 2009

(51) Int. Cl. E05C 17/54

(52) U.S. Cl. 292/344

(57) ABSTRACT

A door security brake that applies a combination of frictional and gravitational force sufficient to secure a door against intrusive force, yet is easily transported in and out of its door securing position. Frictional force is provided by interchangeable frictional pads that face the floor adjacent to a door. Gravitational force is provided by a reservoir which can be filled with a variety of weight materials. Methods for transporting, employing, and storing a door security brake.

### FIELD OF THE INVENTION

The present invention relates generally to a novel door security device. More particularly, the present invention relates to a portable security door stop which exerts a combination of frictional and gravitational force to prevent the movement of a door. The present invention also relates to a method for using a portable security door stop to prevent the entry of and intruder and to prevent the closing of an open door.

### BACKGROUND OF THE INVENTION

Prior art door security blocking devices have generally used the principle of leverage to resist the movement of a door. Force exerted against one side of the door is levered by these devices against the floor on the opposite side to create resistance to the movement of the door. Levering door blocking devices have included wedge-shaped objects designed to fit into a space between door and floor. Examples include U.S. Pat. No. 5,011,203 to Tackett, and U.S. Pat. No. 5,711,560, to Gilbertson. Wedge-like door security devices have several disadvantages. They cannot be used where there is little clearance below the door, for example when weather stripping is present. If the gap between door and floor is sufficiently large, the door can partially open before the wedge is engaged. The opening door gathers momentum before it strikes the wedge, increasing an intruder's ability to displace the wedge, and at the least allowing the intruder to reach inside the door with hand or tools. Most importantly, there is only a small area of contact between the device and the floor. With little surface area, there is little friction between the wedge and the floor, so little lateral frictional force is directed toward the door. The result is that the resistance of the device can be overcome by a relatively small inward force on the door.

Prior art devices have also included braces or props to transfer the force of the door to the floor. These devices have the disadvantage of requiring costly materials of high tensile strength and complex designs, as in the device door brace disclosed in U.S. Pat. No. 4,136,899 to Frasher. Door braces and props also often require the installation of components in the door, floor, or both, as disclosed for example in U.S. Pat. No. 4,019,765 to Nichola. This makes them difficult to move from door to door to meet changing needs. It also makes them no stronger than the fasteners that anchor them.

A most effective principle of door blocking is the application of a combination of gravitational and lateral frictional force to one side of the door. A door cannot be opened if it is opposed by a body of sufficient weight and adhesiveness to the substrate. This principle has not been applied in prior art devices, in part because bodies of sufficient weight are too heavy to be routinely positioned and removed by a person of normal strength and agility, and in part because means of providing sufficient frictional force against a floor have been lacking.

### SUMMARY OF THE INVENTION

The present invention provides a security door stop that applies a combination of frictional and gravitational force sufficient to secure a door against intrusive force, yet is easily transported to and from its door securing position. The tenacious hold of the security door stop on a substrate is produced by a novel combination of weight acting upon an interchangeable frictional surface that optimally engages the weight with the substrate. The transportability of the security door stop of the present invention is achieved through novel features including wheels or a slidable surface to facilitate movement across a substrate, and a fillable reservoir that enables the user to reduce or remove the weight of the security door stop for transport. Variations on the security door stop of the present invention enable the user to secure both inward opening doors and outward opening doors.

The present invention also provides a security door stop that can be fabricated at any conceivable scale to secure any conceivable door, and that can be constructed from inexpensive materials of low tensile strength.

The present invention further provides methods of transporting, deploying, and storing a security door stop that applies a combination of frictional and gravitational force sufficient to secure a door against an opening force.

The preferred embodiment of the security door stop of the present invention includes container means to contain a weight material; frictional means to engage the weight of that material with a substrate, typically a floor adjacent to a door; and abutment means for contacting the surface of a door. A preferred embodiment also includes transport means for moving the security door stop into and out of position. The preferred rectanguloid form of the security door stop provides a large surface area over which frictional means can engage the floor. In a preferred embodiment, container means is a reservoir capable of being filled and emptied, and the contained weight material is water. By filling or emptying the reservoir, the user can adjust the weight of the security door stop as needed for security, transportation, and storage.

In a preferred embodiment, frictional means is an interchangeable pad selected by a user according to the nature of a floor. For a smooth floor, the present invention provides a pad of rubber treads that individually grip the floor. The gripping action of the plurality of rubber treads provides a large accumulative resistance force. Also, as the rubber treads are shifted into the engaged position, a great amount of force is absorbed into the frictional pad. Once engaged, the rubber treads stretch and rebound, providing additional resistance force. For a carpeted floor, the present invention provides a pad that bears teeth or nubs, in addition to friction bearing rubber treads, to engage the fibers a carpet.

The security door stop of the present invention is generally positioned on the side of a door interior to the space to be secured, with abutment means firmly in contact with a door surface. This prevents an intruder from interfering with the security door stop. In a preferred embodiment, abutment means is a sidewall of the security door stop, protected by a shock absorbing frictional pad. The shock absorbing frictional pads create an opposing force of resistance to the bottom pad, preventing momentum from an inward opening door. In situations in which a door opens outward from the space to be secured, the security door stop can be still be positioned on the interior side of the door, but in an embodiment that includes a chain or wire and bracket that attaches to the underside of the door. By means of this chain or wire and bracket, the frictional resistance and gravitational force of the security door stop are deployed to counteract an outward intrusive force.

In the preferred embodiment, transport means is at least one wheel, more preferably two wheels, to permit rolling movement across a substrate; and a handle opposite the wheels to facilitate rolling movement. As the security door stop of the present invention can be of any conceivable size to match any conceivable door, a variety of transport means is also provided. For larger embodiments, transport means can include motorized wheels. For smaller embodiments, transport means can include a handle and a slidable surface to enable a user to drag the security door stop easily over a substrate. Transport means can also include only a handle.

The preferred security door stop of the present invention secures a door when it is in prone position i.e. with frictional means in contact with the substrate and one sidewall is in contact with the door. The security door stop is taken out of operation and readied for transport or storage by grasping the handle and pivoting the reservoir about the axle of the wheels into travel position, i.e. a partially upright position with long axis between approximately one degree and 90 degrees above the substrate. The security door stop may be rested or stored in fully upright position, i.e with long axis approximately 90 degrees above the substrate. A support foot is provided so that the security door stop rests stably in upright position.

In a preferred embodiment, container means includes a balancing wing, a branch of the reservoir that extends higher than the water filling line when the security door stop in prone position. The balancing wing is therefore empty of water when the security door stop is in prone position. When the security door stop is pivoted into travel position, the balancing wing fills at least partially with water. This shifts the center of gravity downward and over the wheels, thereby facilitating rolling movement.

The security door stop of the present invention may also be utilized as a door stop to limit or prevent the movement of an open door in any direction.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a side view of the security door stop of the present invention in position to counteract intrusive force against a door;

FIG. 2 is a top oblique perspective view of the security door stop;

FIG. 3 is a longitudinal cross section of the security door stop taken at the level of the filling port;

FIG. 4 is a bottom oblique perspective view of a security door stop showing a tread-bearing embodiment of a frictional pad;

FIG. 5 is a side detail view of multiple embodiments of the frictional pad of a security door stop;

FIG. 6 is a top view of a security door stop;

FIG. 7 is a side view of a security door stop;

FIG. 8 is a bottom view of a security door stop;

FIG. 9 is a top view of an embodiment of a security door stop that excludes wheels;

FIG. 10 is a side view of an embodiment of a security door stop that excludes wheels;

FIG. 11 is a top oblique perspective view of an embodiment of a security door stop that excludes wheels;

FIG. 12 is a bottom view of an embodiment of a security door stop that excludes wheels.

FIG. 13 is a longitudinal cross section of an embodiment of a security door stop that excludes wheels;

FIG. 14 is a side view of a wedge shaped embodiment of a security door stop;

FIG. 15 is a side view of an embodiment of a security door stop that is a pentagonal solid;

FIG. 16 is a side view of an embodiment of a security door stop that prevents the outward movement of a pivoting door;

FIG. 17A is a side view of a security door stop including a burglar alarm with a motion sensor affixed to an external surface;

FIG. 17B is a side view, partially cut away, of a security door stop including a burglar alarm, with a buoyant motion sensor floating on the surface of liquid weight material;

FIG. 18A is a side view of a security door stop with motorized retractable wheels, with wheels in engaged position;

FIG. 18B is a side view of a security door stop with motorized retractable wheels, with wheels in retracted position; and

FIG. 19 is a side view of a security door stop adapted for movement along a door-mounted track.

### DESCRIPTION OF THE PREFERRED EMBODIMENTS

The following detailed description illustrates the invention by way of example and not by way of limitation. This description will clearly enable one skilled in the art to make and use the invention, and describes several embodiments, adaptations, variations, alternatives and uses of the invention as disclosed, including what we presently believe is the best mode of carrying out the invention.

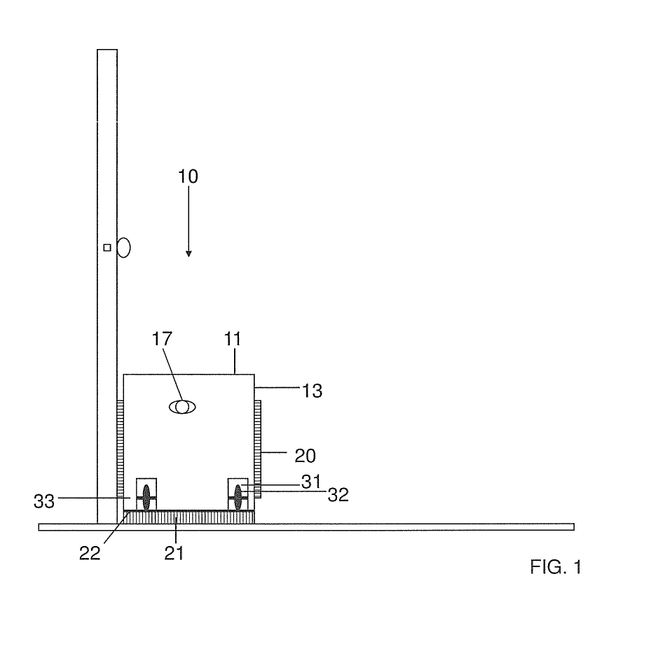

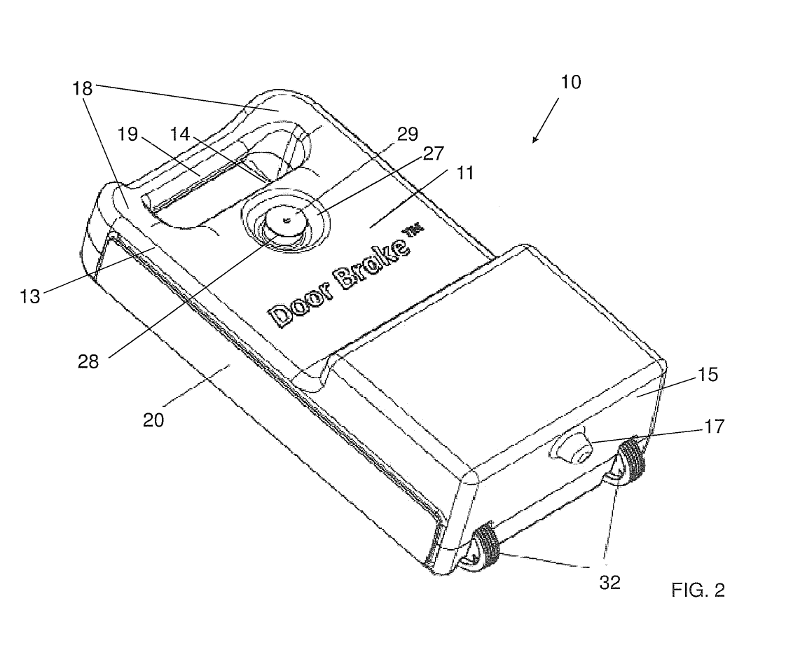

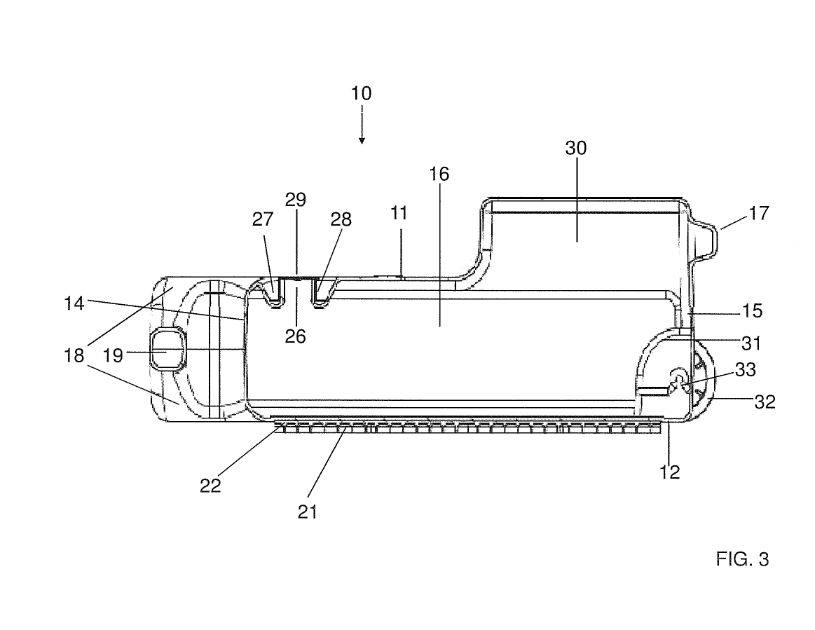

Security door stop, as generally shown in 10, is a generally rectanguloid hollow body, preferably of a molded plastic material. Security door stop 10 includes an elongated top wall 11 located over an elongated bottom wall 12, both of which are joined to two opposing side walls 13, and to two opposing end walls, designated handle end wall 14, and platform end wall 15, to define a reservoir 16. The inner surfaces of all walls are defined as those facing reservoir 16; outer surfaces of all walls are defined as those opposite the inner surfaces. Bottom wall 12 is essentially planar. Platform end wall 15 is essentially planar except for the provision of at least one outwardly projecting support foot 17. Preferably there is a single support foot 17 located in the center of the upper side of platform end wall 15 as shown in FIG. 1. Handle end wall 14 includes two outwardly projecting portions 18 joined by handle 19, such that handle 19 generally spans the distance between sidewalls 13. In the preferred embodiment, wherein security door stop 10 is formed of blow molded or injection molded plastic, handle 19 is unitarily formed with projecting portions 18. Alternatively, handle 19 can comprise a separate unit attached by any attachment means well known in the art. In all cases it is essential that handle 19 be situated so as not to disrupt the planar nature of bottom wall 12 or to interrupt the contact of bottom wall 12 with substrate. Side walls 13, handle end wall 14, and platform end wall 15 can be completely planar or they may curve at their edges to smoothly join top wall 11 and bottom wall 12, as shown in FIG. 2.

In the preferred embodiment, abutment means includes either of two sidewalls 13, and a shock absorbing frictional pad 20 affixed to each sidewall 13. Affixation is preferably by means of cement, glue, or double sided tape. Less preferably affixation may be by any attachment hardware such as screws, rivets, or clips.

Frictional pad 21 is affixed to bottom wall 12 by means of an intervening adhesive layer 22. Preferably, adhesive layer 22 and frictional pad 21 cover as much of bottom wall 12 as possible, to maximize the frictional surface area available to engage a floor. Adhesive layer 22 may be shaped so as to conform exactly to the shape of frictional pad 21. Preferably, adhesive layer 22 is permanently affixed to bottom wall 12. Attachment of frictional pad 21 to adhesive layer 22 is preferably reversible, and mediated by a hook and loop fabric system such as Velcro®. Reversible attachment facilitates the interchange of various embodiments of frictional pad 21. In this manner, frictional pads 21 of particular texture and composition can be matched to particular substrates. Reversible attachment also facilitates the cleaning of frictional pad 21. Alternatively, frictional pad 21 may be attached persistently or permanently to bottom wall 12 by glue, double sided tape, or any other attachment means known in the art.

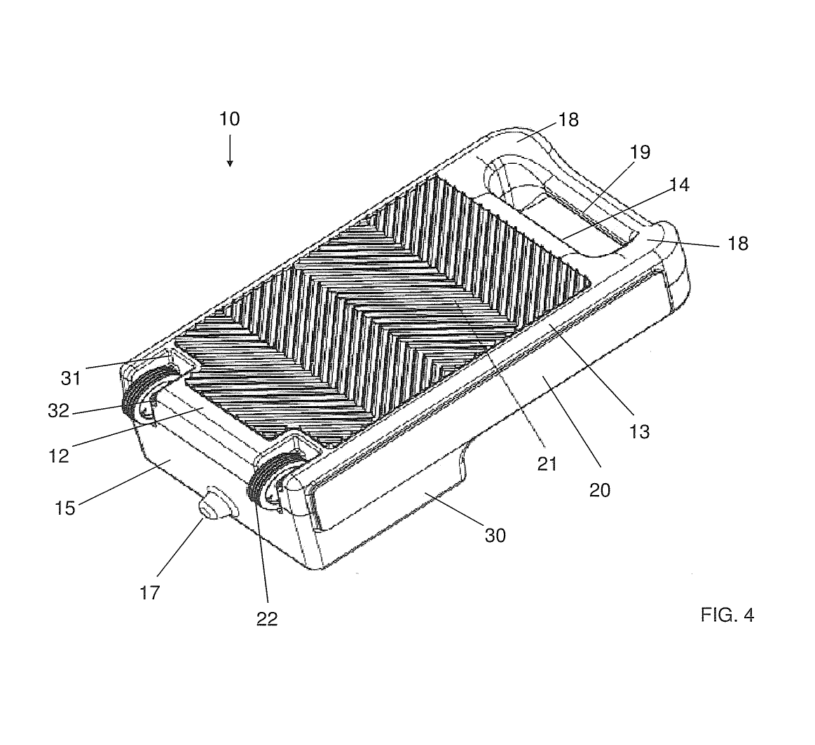

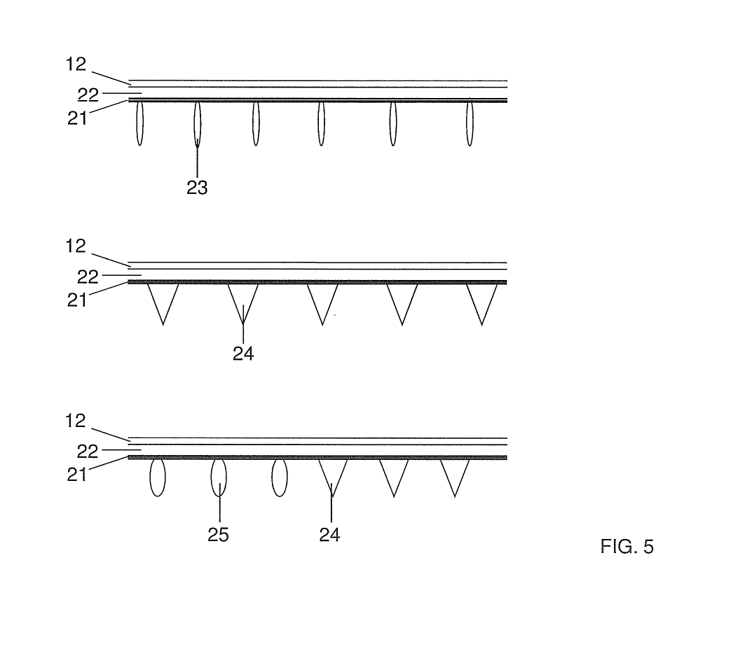

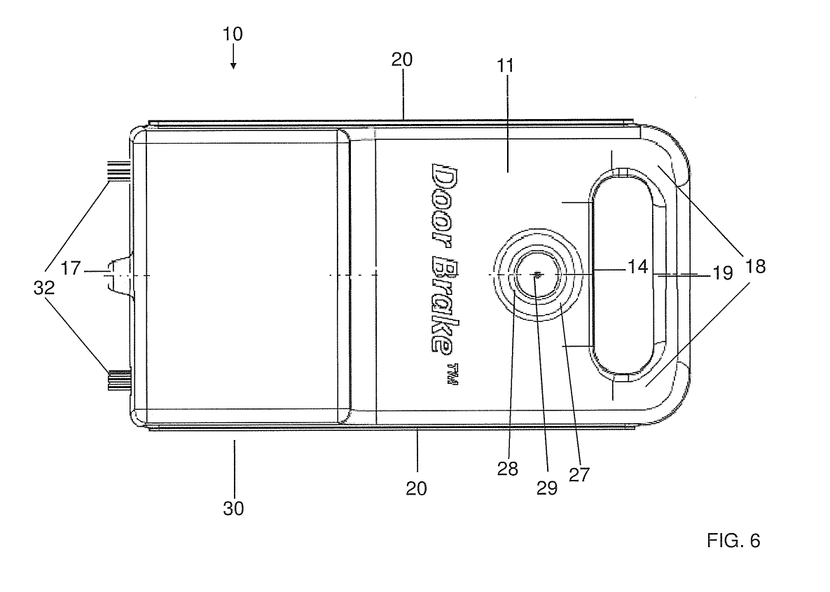

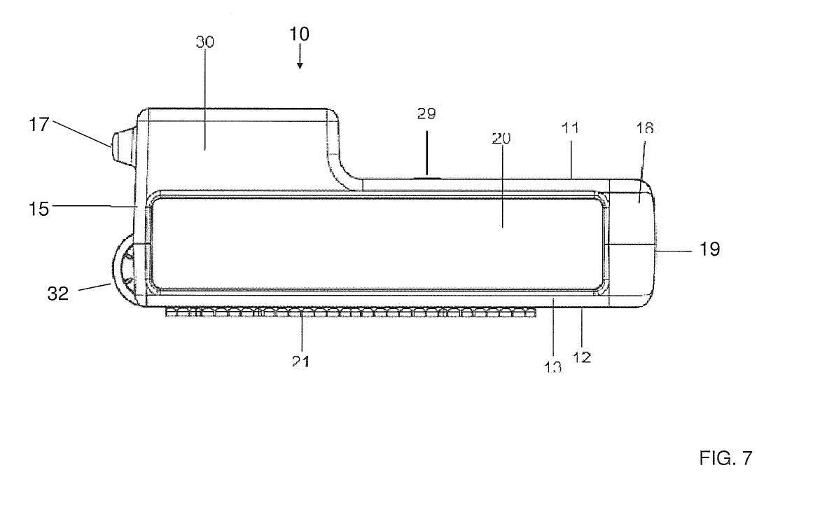

One preferred embodiment of frictional pad 21 is shown in FIG. 4. It is a rubber or plastic pad whose floor facing surface bears a plurality of treads 23. A frictional pad 21 composed of pliable rubber or plastic is optimally suited to frictionally engage smooth surfaced floors such as those of lineoleum, wood, or finished concrete. For surfaces likely to be wet, such as the deck of a boat, a frictional pad 21 composed of a wettable composition such as foam rubber is optimal. The adhesion of the water molecules to the wettable surfaces of frictional pad 21, combined with the cohesion between water molecules in a thin water film, will produce especially strong binding of frictional pad 21 to a wet floor. Further alternative embodiments of frictional pad 21 are optimal for use on carpeted floors. These embodiments bear a plurality of teeth 24; plastic nubs 25; or a combination of teeth 24 and plastic nubs 25, as FIG. 5. Still further alternative embodiments of frictional pad 21 include those with floor facing surfaces bearing one or more metal or plastic cleats (not shown) suitable for engaging earth or grass surfaces, or rough surfaces such as unfinished concrete. Other embodiments of frictional pad 21 also include those with floor facing surfaces coated with pressure sensitive removable adhesives similar to the adhesive of Post-it Notes® (not shown).

Top wall 11 includes filling port 26 which opens into reservoir 16. Preferably, filling port 16 is centered within an indentation 27 of top wall 11 and is surrounded by a neck 28 which extends upward to a level flush with the rest of top wall 11. Neck 28 preferably accepts a fluid-tight snap-on cap 29, which allows a user to seal off reservoir 16 in a fluid-tight manner.

When in use, reservoir 16 is filled via filling port 26 with a weight material 45. Preferably weight material 45 is water, although any fluid compatible with the structural materials of security door stop 10 may be used. Alternatively, a flowable solid such as sand or metal shot may be used. In either case, the weight conferring material is admitted to reservoir 16 via filling port 26 and is sealed in place with cap 29. In an alternative embodiment, reservoir 16 can be permanently filled with a liquid, a flowable solid, or a non-flowable solid such as cement, concrete, wood, or a metal.

The preferred embodiment of security door stop 10 includes balancing wing 30, which is essentially an upward protrusion of reservoir 16. Balancing wing 30 is formed by an upward extension of top wall 11 spanning the distance between upward extensions of sidewalls 13 and platform end wall 15. In the preferred embodiment, the upward extensions of sidewalls 13 and platform end wall of a height that creates a balancing wing 30 that is approximately 1.5× higher than handle end wall 14. Balancing wing 30 is asymmetrically disposed toward platform end wall 15, relative to a center line bisecting security door stop 10 between handle end wall 14 and platform end wall 15. In the preferred embodiment, the length of balancing wing 30 occupies approximately 40% of the length of sidewalls 13 and 100% of the length of platform end wall 15.

Preferably security door stop 10 is fabricated as a single unit from injection molded or blow molded plastic, but it can alternatively be constructed of individually formed parts. Reservoir 16 is preferably integral to the structure but can alternatively be provided as a separate container or liner. In one such alternative embodiment (not shown), security door stop 10 is constructed from metal parts joined by bolting, welding, or other suitable means, which enclose reservoir 16 as a separate plastic container. In still another alternative embodiment, security door stop 10 is constructed of plastic and armored with a puncture resistant cladding of steel, aluminum, Kevlar®, or other puncture resistant material. In this embodiment, security door stop 10 is resistant to attempts by an intruder to puncture reservoir 16 with a sharp object to release weight material.

An advantage of security door stop 10 is that it can be fabricated at any size suitable to secure doors of any conceivable size and weight. In a preferred embodiment, suitable to secure the front door of a typical home, reservoir 16 contains approximately 924 cubic inches of water and provides a weight of approximately 33 pounds.

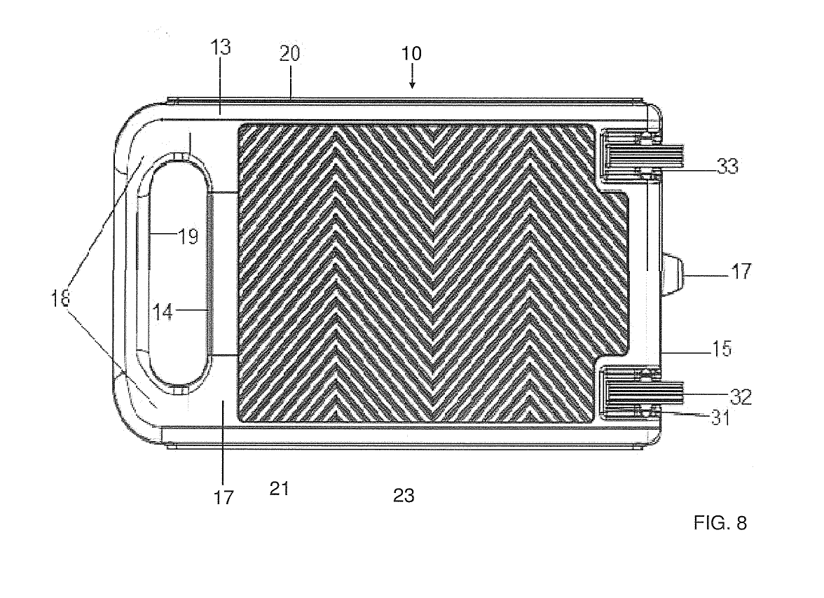

In a preferred embodiment of security door stop 10 the interface between bottom wall 12 and platform end wall 15 is indented to define at least one wheel recess 31 whose closed face extends into reservoir 16 and whose open face opens through bottom wall 12 and platform end wall 15. Preferably there are two wheel recesses 31, each located proximate to a corner defined by the intersection of bottom wall 12 and platform end wall 15. Each wheel recess 31 contains a wheel 32 rotatably fixed to a rigid axle 33. Axle 33 can be mounted into wheel recess 31 and engaged to wheels by any means of wheel and axle attachment known in the art. Wheel 32 is preferably composed of a durable plastic such as high density polyethylene or nylon, or of metal, or of wood. For large and heavy embodiments of security door stop 10, wheel 32 may include inflatable tires. Axle 33 is preferably composed of rigid metal or durable plastic such as high density polyethylene or nylon. It is essential that wheel recesses 31 be situated such that wheels 32 are flush with bottom wall 12 as shown in FIG. 8. Situated in this manner, wheels 32 do not to disrupt the planar nature of bottom wall 12 and therefore do not interrupt contact of frictional pad 21 with a substrate when security door stop 10 is in prone position. It is also of course essential that wheels 32 project outward from platform wall 15 sufficiently to contact the substrate when security door stop 10 is in travel position. Preferably, wheels 32 project beyond platform wall 15 to a distance identical to the height of support foot 17, so that security door stop 10 is level when resting in upright position, upon wheels 32 and support foot 17.

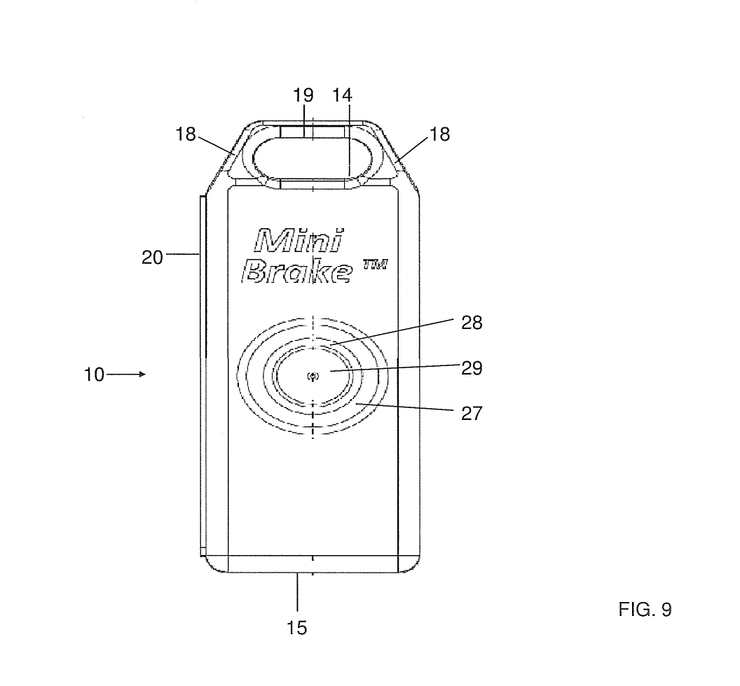

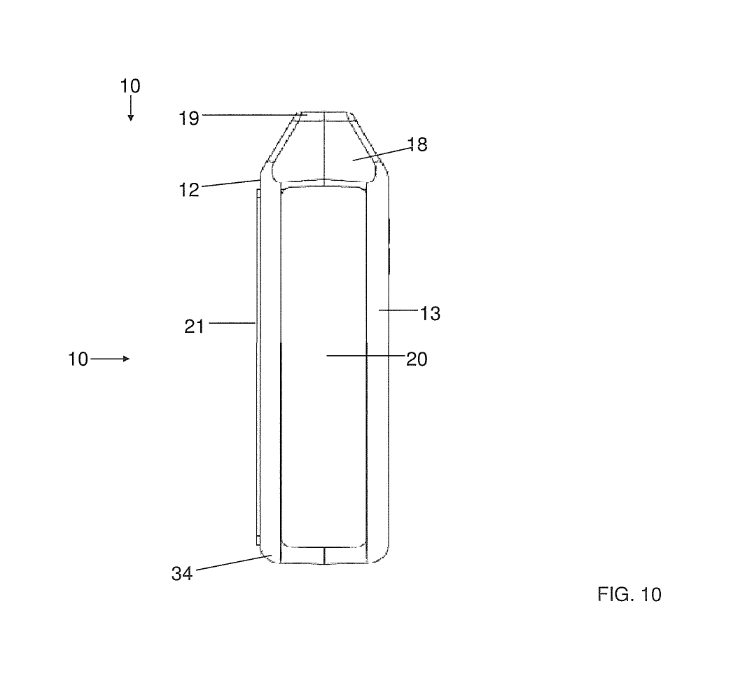

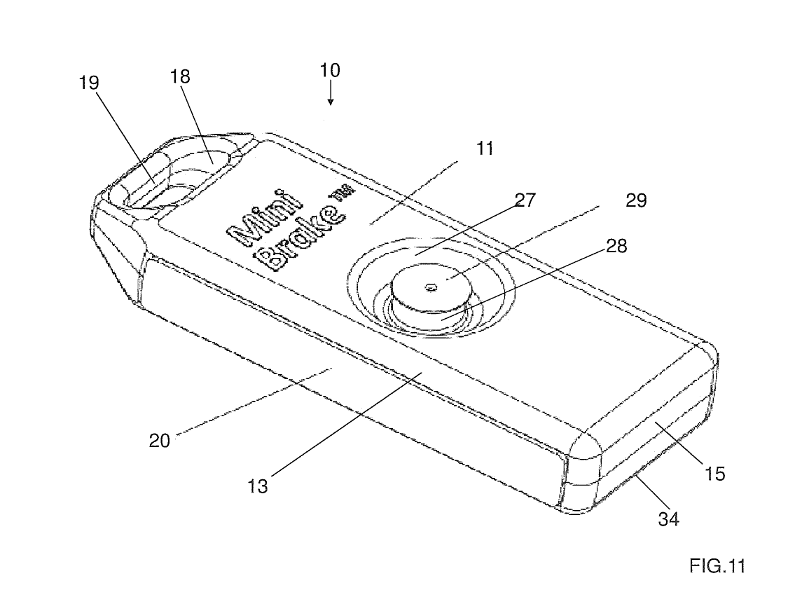

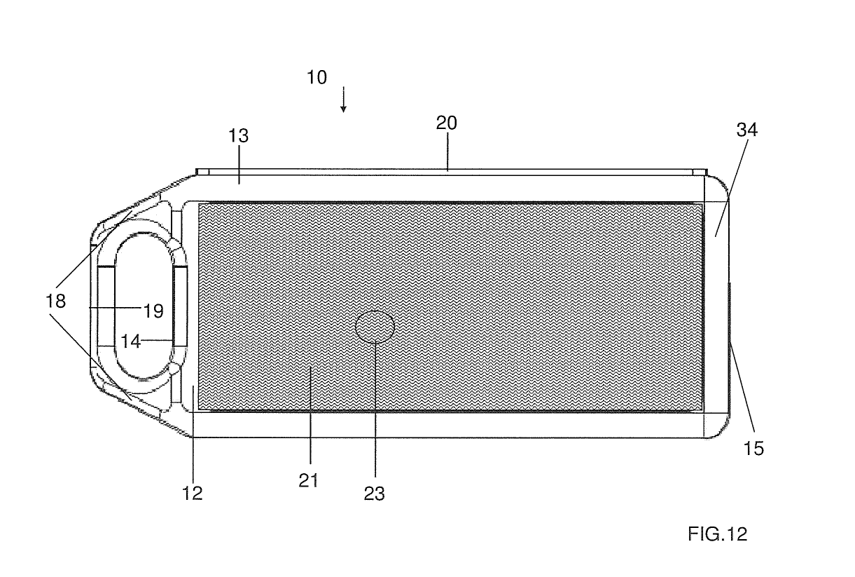

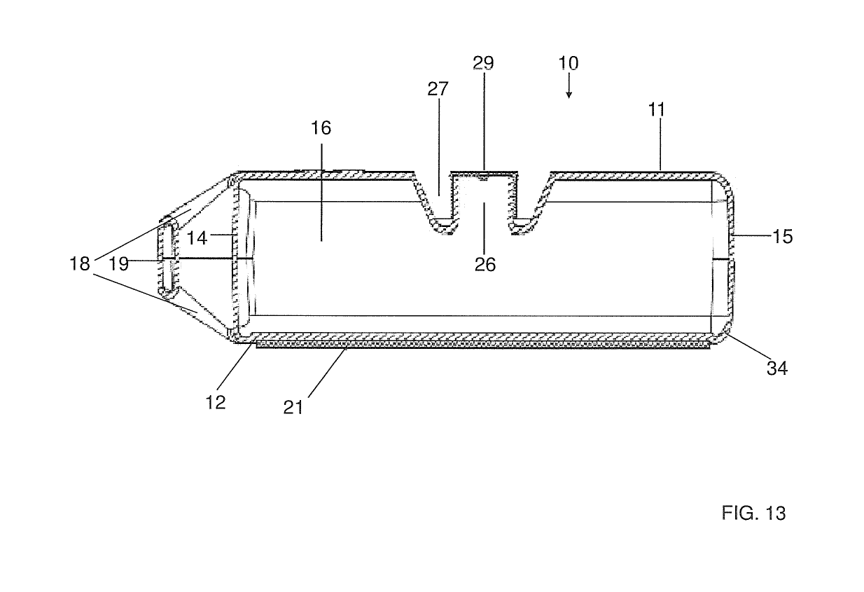

An alternative embodiment of security door stop 10 is adapted for transport by a sliding or dragging movement across a substrate, or by being carried without contact with substrate. This embodiment, shown in FIGS. 9-13, transport means does not include wheels 32, wheel recesses 31, or axles 33. Transport means instead includes slidable surface 34. A slidable surface is one whose frictional properties are low enough to permit easy dragging movement across a surface and durable enough to sustain repeated movement without significant damage. Preferably slidable surface 34 is faced with a polyfluorocarbon such as Teflon®. Alternatively, the plastic from which security door stop 10 is constructed may possess appropriate frictional and durability properties to provide slidable surface 34 without further modification. Transport means that exclude wheels are well suited to embodiments of security door stop 10 that are small and light in weight, but are not limited to them.

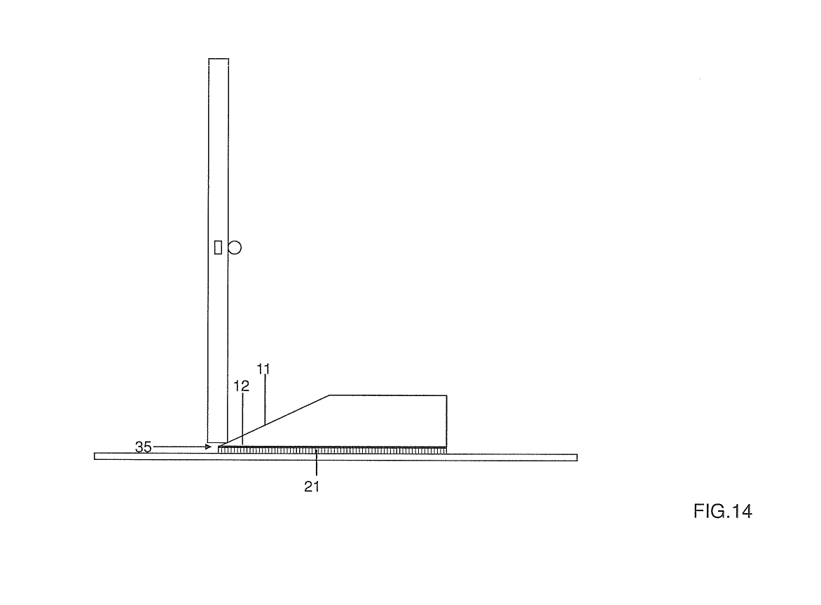

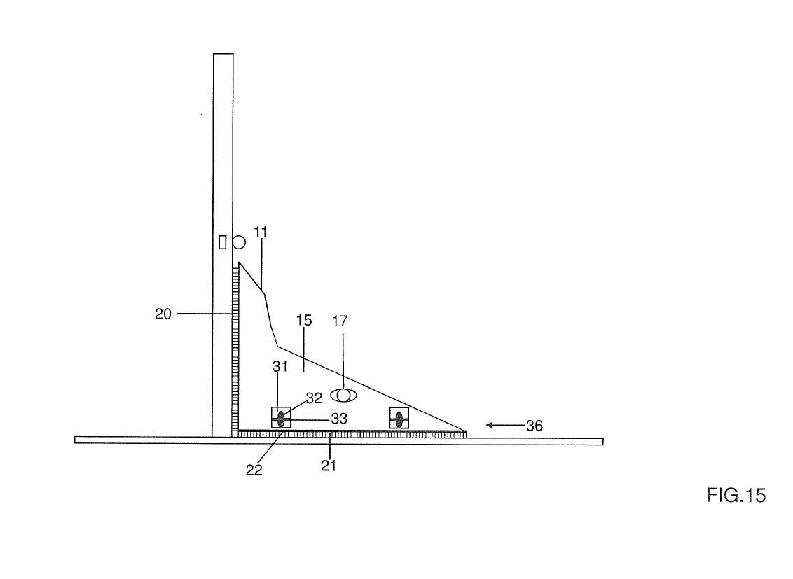

In an alternative embodiment, security door stop 10 is not rectanguloid but generally wedge shaped, wherein upper wall 11 slopes downwardly to join directly to bottom wall 12 to form a wedge-shaped leading edge 35 that can be inserted under the bottom edge of a door (FIG. 14). In this embodiment, some of the door opening force is transferred by leverage to the substrate, further increasing the effectiveness of the security door stop. Another embodiment that utilizes leverage is a security door stop 10 which is an irregular pentagonal solid wherein one side wall 13 broadly contacts a door, and upper wall 11 slopes downwardly on three steps to join directly to bottom wall 12 to form a wedge-shaped trailing edge 36, that is, a wedge contralateral to a door (FIG. 15). Other non-rectanguloid shapes are of course possible, limited only by the capabilities of fabrication methods and materials. Such non-rectanguloid embodiments may or may not include wheels 32, axles 33, wheel recesses 31, handle 19, or support foot 17, depending on the size and weight of the specific embodiment.

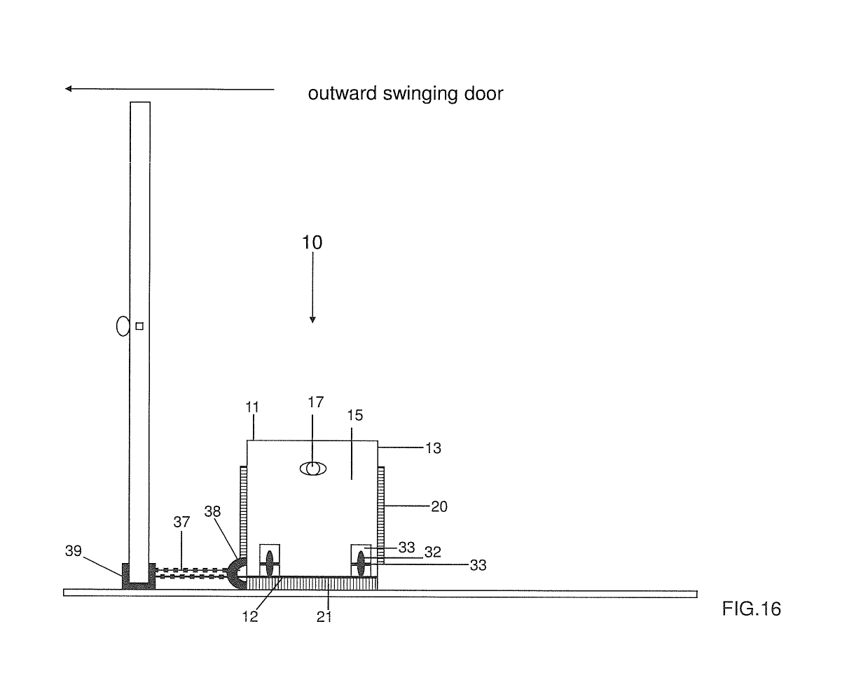

In an alternative embodiment, security door stop 10 is adapted to secure a door against an outward opening force, that is, a force tending to pull a door away from the location of security door stop 10. This situation is encountered, for example, when an interior area is secured by a door that swings toward the exterior (FIG. 16). In this embodiment, security door stop 10 is provided with chain 37, hook 38, and bracket 39. Hook 38 is preferably affixed to one side wall 13 of security door stop 10. Chain 37 joins hook 38 to bracket 39, which is attachable to the underside of a door. Hook 38 can be of any strong and rigid metal or plastic material, and can be affixed to sidewall 13 by any adhesive or fastening means known in the art; or it can be formed integrally with side wall 13. Bracket 39 is formed from a metal or plastic of high tensile strength. It is of a size and shape which conforms closely to the underside of a desired door. It can be formed in a manner which allows it to be slipped onto the underside a door and remain in place by means of frictional force, or it may be affixed to the underside of a door with screws, nails, or similar affixation hardware, or by adhesive means. Chain 37 is adapted to be threaded through hook 38 and also attached to bracket 39. In a preferred embodiment, chain 37 is permanently attached to bracket 39, for example by welds or rivets, in a manner that leaves two free ends of chain 37 to be threaded through hook 38 and closed by a user by means of a clasp or other means known in the art, thereby forming a closed loop. In this embodiment, the lateral force of the pivoting door is transmitted by chain 37 to engage the treads of frictional pad 21 to grip more tightly to the floor. Alternatively a wire loop (not shown) can be substituted for chain 37.

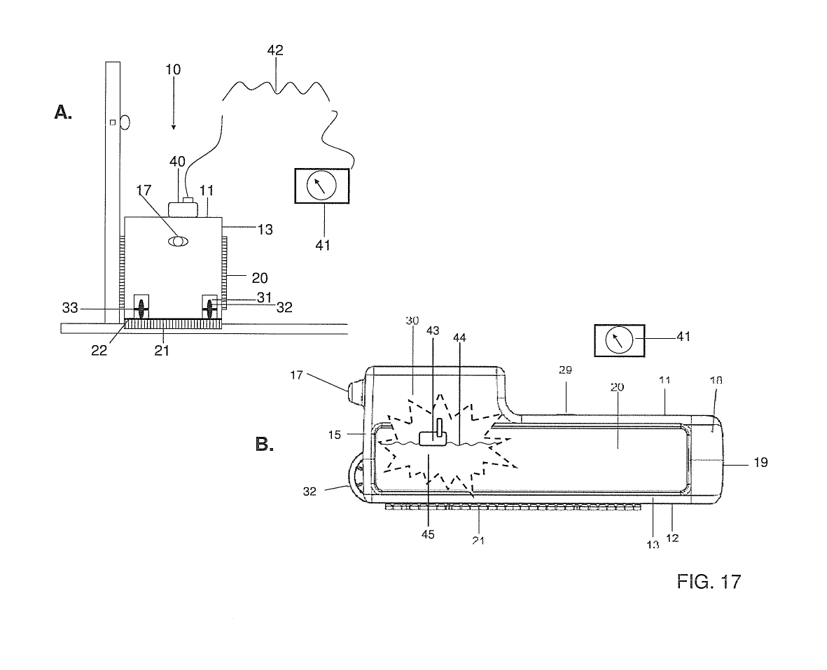

In an alternative embodiment, security door stop 10 includes an alarm triggered by shock or motion. In this embodiment, security door stop 10 not only secures a door but alerts a user to attempts to breach security, and deters further attempts. The alarm can include a motion or vibration sensor of any type well known in the art of burglar alarms, such as a sensor that transmits a signal when a light beam is broken by the motion of an opening door; or a sensor that transmits a signal when a vibration or motion displaces a magnet or causes a trembler device to actuate. In one such embodiment (FIG. 17A), motion sensor 40 is mounted a surface of security door stop 10, preferably an exterior surface. Upon detecting motion, motion sensor 40 transmits a signal to alarm unit 41 via a wireless signal or via wiring 42. In an alternative embodiment (FIG. 17B), buoyant motion sensor 43, powered by an internal battery, floats on the surface 44 of liquid weight material 45 within reservoir 16. When security door stop 10 is disturbed, waves induced on the surface 44 of weight material 45 cause buoyant motion sensor 43 to actuate a wireless signal (not shown) to trigger alarm unit 41. Wireless floating motion sensors are known in the art, e.g. U.S. Pat. No. 4,594,582 to Thompson, and Pool Patrol Pool Alarm, Driven Designs, Inc., Belding, Mich. 48809

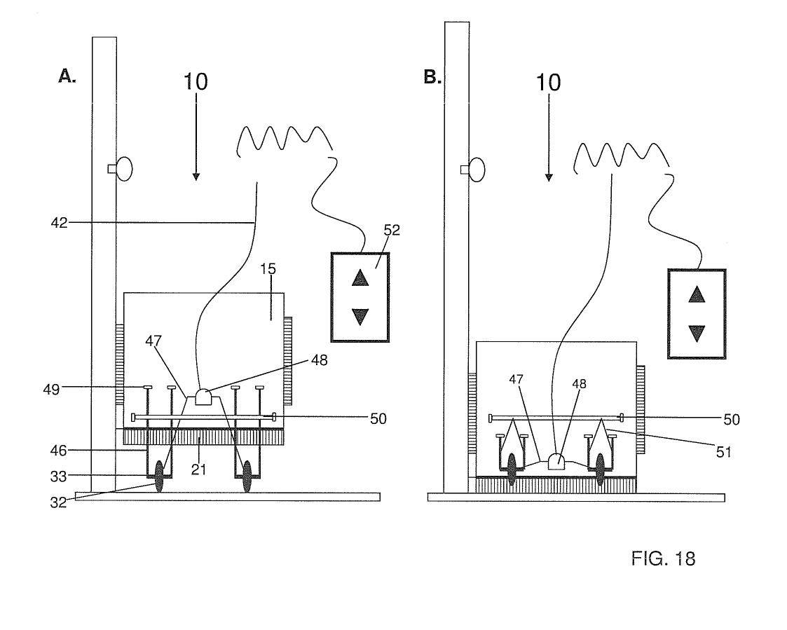

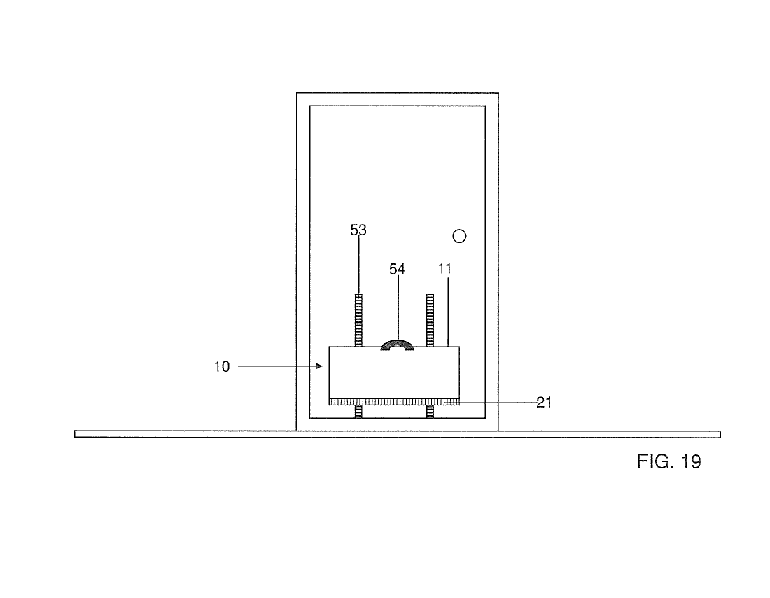

In an alternative embodiment, movement of security door stop 10 is assisted by at least one electric motor engaged directly or indirectly with at least one wheel 32. In an additional alternative embodiment the motor can be operated by remote control, for example by wire or by radio signal. In this embodiment, not only is movement of the security door stop 10 further facilitated, but security door stop can be activated and inactivated from a distance, including from the outside of the secured door. In a preferred embodiment (FIG. 18A,B), security door stop 10 includes at two pairs of wheels 32, each wheel being rotatably engaged to a rigid axle 33, with each wheel 32 and axle 33 being in turn mounted in a retractable wheel mount 46. A first pair of wheels 32, with each wheel in a retractable wheel mount 46, is attached to one end of security door stop 10, preferably to opposite sides of platform end wall 15; a second pair of wheels 32 is similarly attached to handle end wall 11 (not shown). At least one wheel is driven by a battery powered electric propulsion system, that is, at least one wheel is coupled to a transmission 47 driven by a battery powered electric motor 48. Preferably all wheels are so driven. The battery powered electric propulsion system can be of any type known in the art, but is preferably the type disclosed in U.S. Pat. No. 5,937,961 to Davidson. The retractable wheel mounts 46 preferably of the type disclosed by U.S. Pat. No. 4,846,493 to Mason, that is, they are pivotably mounted on hinges 49 on any wall of security door stop 10 in a manner that allows them able to pivot from a retracted position, raised above the floor and out of contact with the floor, to an engaged position, in contact with a floor. Thus, when retractable wheel mounts 46 are pivoted into engaged position (FIG. 18A), security door stop 10 is raised position, that is, out of operation, with frictional pad 21 not in contact with a floor, and with wheels 31 in contact with a floor. In this raised position, security door stop 10 can travel to and from a door. When retractable wheel mounts 46 are in retracted position (FIG. 18B), security door stop 10 is able to secure a door, as frictional pad 21 is in contact with a floor. As in U.S. Pat. No. 4,846,493, the pivoting action of wheel mounts 46 is controlled by at least one horizontally oriented rod 50 which is pivotably attached to a wall of security door stop 10 and which is in turn attached to each retractable wheel mount 46 by means of at least one strut 51. In this arrangement, movement of horizontally oriented rod 50 in the vertical direction causes any attached retractable wheel mount 46 to pivot into or out of the engaged position. Horizontally oriented rod 50 can be moved by the manual force of a user, or it may be operated by an electric motor, preferably the same battery powered electric motor 48 that drives the wheels. In operation, a user desiring to open a door secured by security door stop 10 first manipulates remote control 52 to cause retractable wheel mounts 46 to pivot into the engaged position, or manually pivots retractable wheel mounts 46 into the engaged position, thus raising security door stop 10 up from, and out of contact with, a floor. User then manipulates remote control 52 to activate battery powered electric motor 48 to drive wheels 32 to move security door stop 10 away from a door. Remote control 52 may actuate signals via wires 42 as in FIG. 18 or via wireless signals. Equivalent alternative arrangements for retractable wheels are of course possible, for example, wheels can reside in recesses in side walls 13 and ascend and descend by means of a hydraulic drive (not shown).

In an alternative embodiment, transport means of security door stop 10 includes one or more tracks 53 or rails (not shown) mounted upon a surface of a door. In this embodiment, security door stop 10 can be raised from its door-securing position to a raised position, which permits a door to open. Security door stop 10 is retained in raised position by a catch or chain. Suitable hardware for tracks and retaining means is well known in the art. In this embodiment, security door stop 10 preferably includes top handle 54 attached to top wall 11 to facilitate the raising and lowering process, and may or may not include wheels 32, axles 33, wheel recesses 31, handle 19, and support foot 17.

The following procedure of operation applies to embodiments of security door stop 10 that are not electrically propelled and do not move on tracks or rails. In order to secure a door against opening inward, i.e. into a secured space, user selects a frictional pad 21 appropriate to frictionally engage the specific substrate adjacent to a door and attaches it to adhesive layer 22 of bottom wall 12. User places security door stop 10 proximate to the door, with frictional pad 21 in contact with the substrate and shock absorbing frictional pad 20 of one sidewall 13 in contact with the door. In the preferred embodiment, full intimate contact of shock absorbing frictional pad 21 with the inner surface of the door is essential for the full securing action of security door stop 10, for it prevents the door from being partially opened and gathering momentum before striking security door stop 10. Furthermore, with intimate contact, the lateral force of the opening door is best transmitted to frictional pad 21, where the forced is absorbed to shift the plurality of treads 23 into the engaged position, thereby creating a large accumulative resistance force. The user then fills reservoir 16 with weight material, preferably water, but, alternatively, reservoir 16 can be filled with weight material prior to placement in front of a door. To secure a door against opening outward, i.e. away from a secured space, security door stop 10 is operated as described above, but user chooses an embodiment of security door stop 10 that includes a chain and, after placing security door stop 10 proximate to the inner side of a door, user attaches the chain of security door stop 10 to a bracket on the inner side of the door.

To allow the door to open, user grasps handle 19 and lifts it upward from the substrate, so that security door stop 10 pivots on wheels 32, bringing security door stop 10 to a semi-upright, i.e. traveling, position, wherein all weight is borne on wheels 32. In the preferred embodiment, featuring balancing wing 30 and a fluid weight material, this motion causes a portion of the weight material in reservoir 16 to flow by gravity into balancing wing 30. This moves the center of gravity of security door stop 10 downward and centers it over wheels 32. Essentially, the weight becomes balanced over wheels 32 and this greatly facilitates the rolling movement of security door stop 10. User then exerts lateral force on handle 19 to cause security door stop 10 to roll away from the door and travel to a desired storage location. At the desired storage location, user applies appropriate lateral force on handle 19 to bring security door stop 10 into fully upright position, that is, a stable position in which all weight is borne on wheels 32 and support foot 17. For embodiments of security door stop 10 that are electrically propelled or move on tracks or rails, the procedure of operation is essentially as described above, except for the pivoting and positioning steps which are specific to either electric propulsion on retractable wheels or for movement along a track or rails.

When it is desirable to reduce the weight of security door stop 10, user removes some or all of the weight material from reservoir 16. Preferably this is done by removing cap 29 and tipping security door stop 10 so that weight material pours into a receptacle; or by pumping or siphoning out weight material.

Security door stop 10 can of course be employed as a door stop rather than as a security device. In this use, the operations are as above, but security door stop 10 is deployed at whatever location the user determines to be most advantageous for limiting or stopping the movement of an open door.

While illustrative embodiments of the invention have been disclosed herein, it is understood that other embodiments and modifications may be apparent to those of ordinary skill in the art and it is intended that this invention be limited only by the scope of the appended claims.

### REFERENCES

U.S. Pat. Nos.
5,011,203
5,711,560
4,136,899
4,019,765
5,937,961
4,846,493

The invention claimed is:

1. A door security brake comprising weight containing means, frictional means to engage weight containing means to a floor, and abutment means for abutting against a door surface.

2. A door security brake according to claim 1 further including transport means.

3. A door security brake according to claim 1 wherein said weight containing means further comprises a reservoir containing weight material.

4. A door security brake according to claim 2 wherein transport means further comprises a handle.

5. A door security brake according to claim 4 wherein transport means further comprises at least one wheel.

6. A door security brake according to claim 5 wherein transport means comprises two wheels.

7. A door security brake according to claim 4 wherein transport means further comprises a slidable surface.

8. A door security brake according to claim 3 wherein said reservoir containing weight material further comprises a sealable port, thereby allowing filling and emptying of said weight material.

9. A door security brake according to claim 8 wherein said weight material is a liquid.

10. A door security brake according to claim 9 wherein said liquid is water.

11. A door security brake according to claim 8 wherein said weight material is a flowable solid.

12. A door security brake according to claim 3 wherein said reservoir containing weight material is permanently sealed.

13. A door security brake according to claim 12 wherein said weight material is a liquid.

14. A door security brake according to claim 13 wherein said liquid is water.

15. A door security brake according to claim 12 wherein said weight material is a flowable solid.

16. A door security brake according to claim 12 wherein said weight material is a solid.

17. A door security brake according to claim 3 wherein said reservoir further comprises a balancing wing, said wing being an upward extension of said reservoir which shifts the center of gravity during transport of said door security brake, thereby facilitating transport.

18. A door security brake according to claim 1 wherein said frictional means is a pad affixed to a floor facing surface of said door security brake.

19. A door security brake according to claim 18 wherein said pad further comprises floor facing surface modifications selected from the group including treads, teeth, nubs, cleats, and pressure sensitive adhesive.

20. A door security brake comprising a reservoir defined by an elongated top wall located over an elongated bottom wall, both being joined to first and second opposing side walls and to first and second opposing end walls, wherein said elongated bottom wall includes frictional means for engaging the weight of said door security brake with a substrate, and wherein said first opposing end wall includes transport means selected from the group including wheels and a slidable surface, and said second opposing end wall further includes a handle.

21. A door security brake according to claim 20 wherein said reservoir is rectanguloid.

22. A door security brake according to claim 20 wherein said reservoir is non-rectanguloid.

23. A door security brake according to claim 22 wherein said reservoir is wedge-shaped.

24. A door security brake according to claim 1 wherein abutment means is further defined as a sidewall of said door security brake.

25. A door security brake according to claim 24 wherein said sidewall is protected by a shock absorbing pad.

26. A door security brake according to claim 1 additionally including means to secure a door against an intrusive force directed away from said door security brake.

27. A door security brake according to claim 26 wherein said means to secure a door against an intrusive force directed away from said door security brake includes a means for connecting said door security brake to a bracket attached to the underside of a door.

28. A door security brake according to claim 27 wherein said means for connecting said door security brake to a bracket attached to the underside of a door includes a chain attachable to a hook affixed to said door security brake.

29. A door security brake according to claim 27 wherein said means for connecting said door security brake to a bracket attached to the underside of a door includes a wire attachable to a hook affixed to said door security brake.

30. A door security brake according to claim 5 wherein transport means comprises four wheels.

31. A door security brake according to claim 30 wherein at least one of said four wheels is motorized.

32. A door security brake according to claim 31 wherein said four wheels are additionally mounted in retractable wheel mounts.

33. A method for securing a door against intrusive force directed toward a secured area, including the steps of filling a door security brake with a weight material, equipping at least one wall of said door security brake with a frictional pad appropriate to the substrate adjacent to a door, transporting said door security brake to a site adjacent to a door, and positioning said security door stop so that one wall of said door security brake contacts the inner surface of a door and said at least one wall equipped with a frictional pad is in contact with the substrate.

34. A method for securing a door against intrusive force directed away from a secured area, including the steps of filling a door security brake with a weight material, equipping at least one wall of said door security brake with a frictional pad appropriate to the substrate adjacent to a door, transporting said door security brake to a site adjacent to a door, and positioning said security door stop so that one wall of said door security brake contacts the inner surface of a door and said at least one wall equipped with a frictional pad is in contact with the substrate, and attaching a chain anchored to a bracket in said door to a hook on said door security brake.

35. The method of claim 34 wherein the step of transporting said door security brake further includes the steps of pivoting said door security brake so that wheels of said door security brake are engaged with a substrate, and exerting lateral force to roll said door security brake across said substrate.

36. The method of claim 35 wherein the step of transporting said door security brake further includes the steps of pivoting said door security brake so that wheels of said door security brake are engaged with a substrate, and exerting lateral force to roll said door security brake across said substrate.

37. The method of claim 34 wherein the step of transporting said door security brake further includes the steps of pivoting said door security brake so that a slidable surface of said door security brake is engaged with a substrate, and exerting lateral force to drag said door security brake across said substrate.

38. The method of claim 35 wherein the step of transporting said door security brake further includes the steps of pivoting said door security brake so that a slidable surface of said door security brake is engaged with a substrate, and exerting lateral force to drag said door security brake across said substrate.

39. The method of claim 36 wherein the step of transporting said security brake further includes the step of activating an electric motor to drive said wheels across a substrate.

40. The method of claim 37 wherein the step of transporting said security brake further includes the step of activating an electric motor to drive said wheels across a substrate.

41. The method of claim 34 wherein the step of positioning said security door stop includes sliding said security door stop along tracks installed on the inner surface of a door.

42. A method of lightening a door security brake for travel or storage including the step of emptying weight material from the reservoir of said door security brake.
